(19) United States
(12) Patent Application Publication
(10) Pub. No.: US 2005/0235301 A1
(43) Pub. Date: Oct. 20, 2005

(54) Optical disk drive

(75) Inventor: Chung-Ping Chuang, Taipei (TW)

Correspondence Address: BIRCH STEWART KOLASCH & BIRCH, PO BOX 747, FALLS CHURCH, VA, 22040-0747, US

(73) Assignee: BENQ CORPORATION

(21) Appl. No.: 11/099,620

(22) Filed: Apr. 6, 2005

(30) Foreign Application Priority Data
Apr. 14, 2004 (TW) 93110332

(51) Int. Cl. G11B 33/02; G11B 33/14

(52) U.S. Cl. 720/647

(57) ABSTRACT

An optical disk device. The optical disk device comprises a housing, a tray, and a cover. The housing comprises an opening and a first side. The tray is movably disposed in the housing, parallel to the first side and ejectable from the opening. The cover comprises an upper surface. When the tray is closed, the cover blocks the opening and the upper surface of the cover is substantially as high as the first side of the housing.

### BACKGROUND

The invention relates to an optical disk drive and in particular to an optical disk drive with a protective cover design.

Optical disk drives such as CD-ROM drives have been widely used in multimedia electronic computer product systems, and more particularly for desktop computers. Currently, the reading speed of optical disk drives has increased significantly with the development of optical data storage medium technology. Some high speed optical drives (48× or higher) can become dangerous when used with low quality CDs containing small cracks. The CD can shatter, and in exceptional circumstances fragments of the broken CD can be expelled at high speed through any gap in the front cover of the drive, causing serious injury.

FIG. 1A is a perspective view showing a conventional optical disk drive 2. The optical disk drive 2 comprises a housing 20, a panel 23, and a tray 24. The panel 23 comprises a frame with an opening 200 in the middle. The tray 24 loads a disk 28 and is movably disposed in the housing 20. The tray 24 comprises a cover 21 attached thereto. The cover 21 corresponds to the opening 200. The cover 21 blocks the opening 200 when the tray 24 is closed entirely in the housing.

FIG. 1B is a cross section viewed along line AA of FIG. 1A when the tray 24 is closed. FIG. 1C is a cross section viewed along line AA of FIG. 1A when the tray 24 is open.

When the disk 28 is rotated at a high speed (48× or higher speed), the disk 28 may be incapable of sustaining high rotational speed. Since the disk 28 is located directly behind the cover 21 on the tray 24, the impact of the broken CD on the tray 24 causes the tray 24 to become deformed and sink. The result is that the disk 28 can be further damaged or possibly shatter, causing fragments of the broken CD to be expelled from the optical disk drive 2 at high speed through the front cover 21 of the drive. That is, the broken CD may possibly pass through a gap 201 between the panel 23 and the cover 21, to be expelled from the housing 20 of the optical disk drive 2 along a direction shown by an arrow P in FIG. 1B. As a result, the broken CD not only damages the optical disk drive, but also could cause serious physical injury.

Hence, there is a need for an optical disk drive with a protective structure.

### SUMMARY

Accordingly, an embodiment of the invention provides an optical disk drive that prevents CD fragments from being expelled from the optical disk drive, thus preventing potential physical injury.

A embodiment of the invention provides an optical disk device comprising a housing, a tray, and a cover. The housing comprises an opening and a first side. The tray is movably disposed in the housing, parallel to the first side and ejectable from the opening. The cover comprises an upper surface. When the tray is closed, the cover blocks the opening and the upper surface of the cover is substantially as high as the first side of the housing.

The cover connects to the tray. The cover blocks the opening and contacts the first side when the tray is closed. In the first embodiment, the cover further comprises a first bent portion with the upper surface. When the tray is closed, the first side is partially overlaid with the first bent portion.

In the second embodiment, the cover further comprises a second bent portion with the upper surface. When the tray is closed, the second bent portion is partially overlaid with the first side.

In the preferred embodiment, the cover further comprises a groove to contain a front edge of the first side. When the tray is closed, the front edge is disposed in the groove.

The housing further comprises a panel, disposed under the cover.

The panel further comprises an extending portion. The extending portion extends from the panel toward the tray; when the tray is closed, the cover partially overlaps the extending portion.

The extending portion extends a distance in the housing and turns toward the tray.

The extending portion comprises an L-shaped cross section.

A detailed description is given in the following embodiments with reference to the accompanying drawings.

### BRIEF DESCRIPTION OF THE DRAWINGS

Embodiments of the invention can be more fully understood by reading the subsequent detailed description and examples with references made to the accompanying drawings, wherein:

FIG. 1A is a perspective view showing a conventional optical disk drive;

FIG. 1B is a cross section viewed along line AA of FIG. 1A when the tray is closed;

FIG. 1C is a cross section viewed along line AA of FIG. 1A when the tray is open;

FIG. 2A is a schematic cross section of an optical disk drive according to an embodiment of the invention;

FIG. 2B is a schematic cross section of an optical disk drive according to an embodiment of the invention when the tray is closed; and

FIG. 2C is a schematic cross section of an optical disk drive according to an embodiment of the invention when the tray is open.

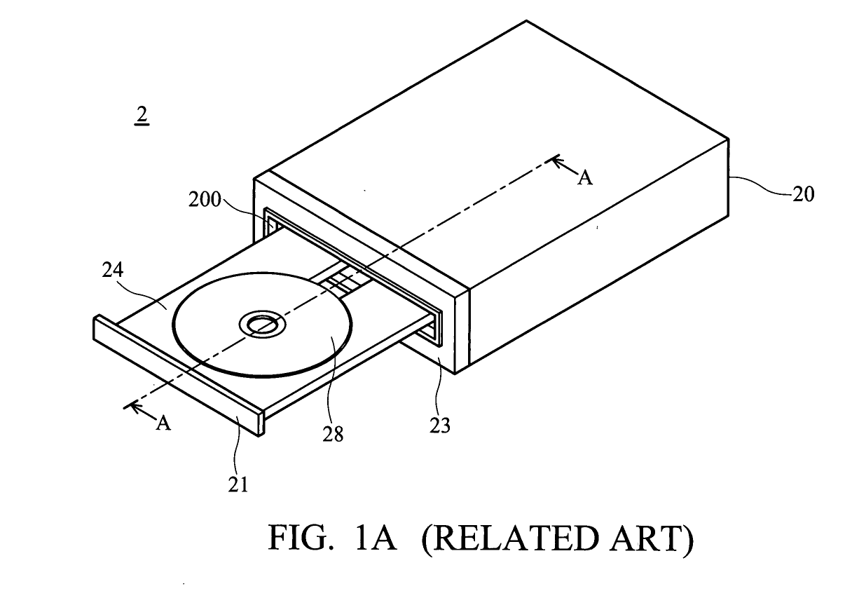

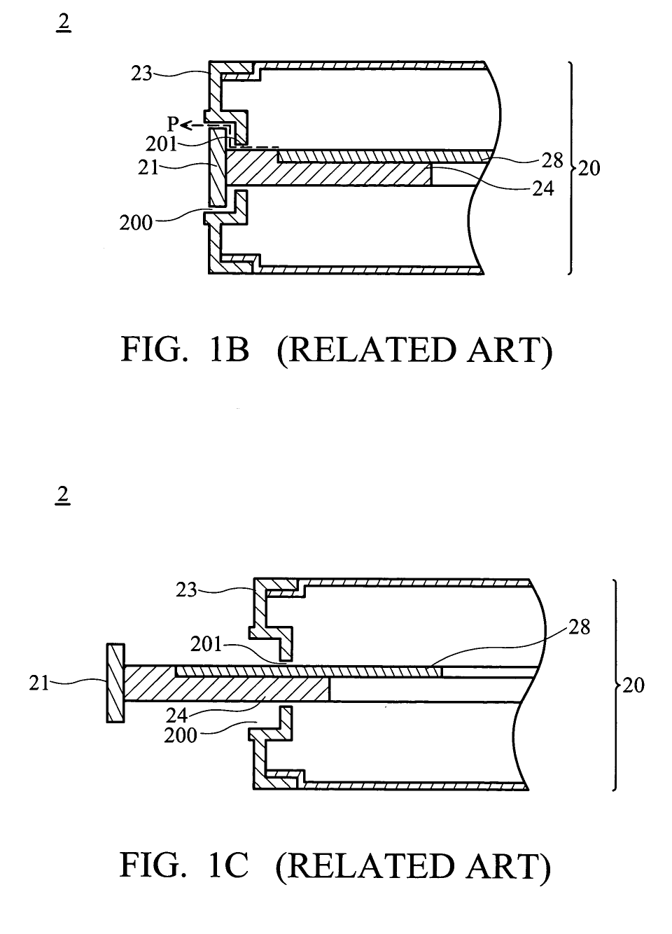

### DETAILED DESCRIPTION

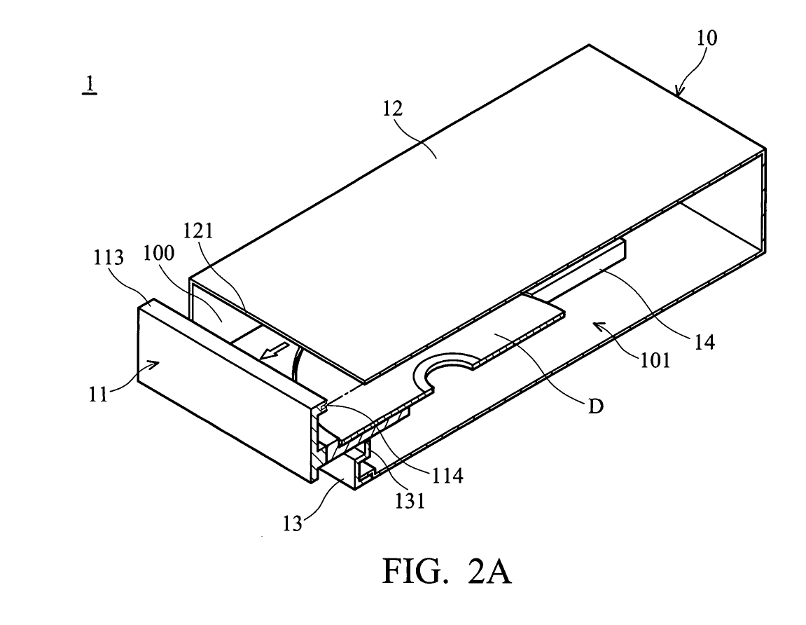

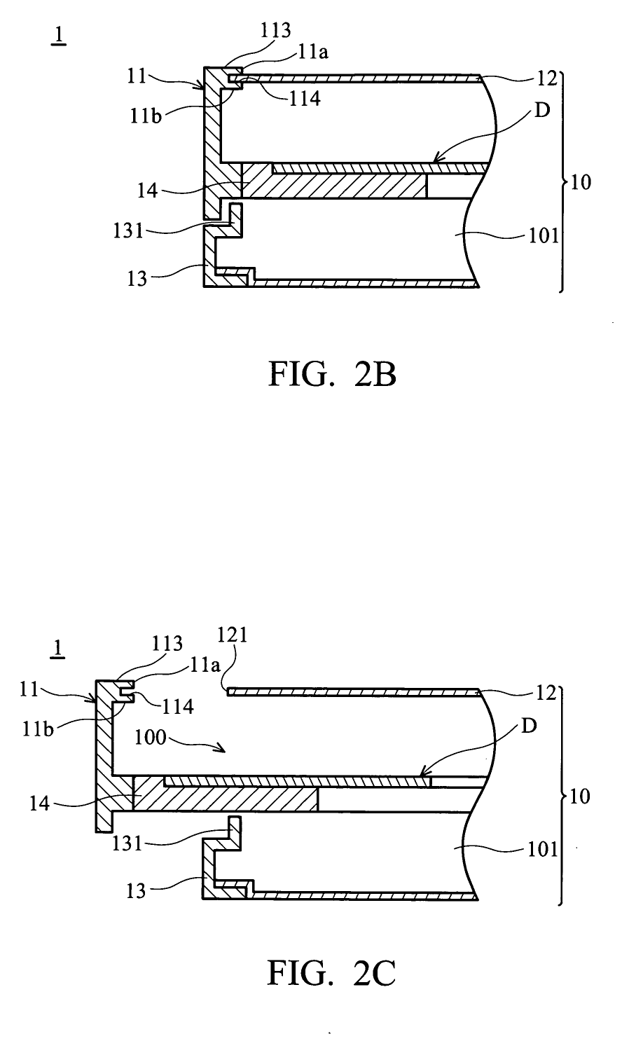

FIG. 2A is a schematic cross section of an optical disk drive 1 according to an embodiment of the invention. Note that only a side of the optical disk drive 1 is shown in cut away to illustrate the internal portion 101 of the optical disk drive 1.

The optical disk drive 1 comprises a housing 10, a tray 14, and a cover 11. The housing 10 comprises an opening 100, a first side 12, and a panel 13. The first side 12 having a front edge 121 is an upper side of the optical disk drive 1. The tray 14 is disposed in the housing 10 to load a disk D and moves through the opening 100. The cover 11 connects to the tray 14. The panel 13 of the housing 10 is disposed under the cover 14 with function keys, microphone ports and indicator lights thereon. The panel 13 further comprises an extending portion 131, extending toward the internal portion 101 of the housing 10 for a distance and turning toward the tray 14. Namely, the extending portion 131 has an L-shaped cross section.

FIG. 2B is a schematic cross section of the optical disk drive 1 according to an embodiment of the invention when the tray 14 is closed. FIG. 2C is a schematic cross section of the optical disk drive 1 according to an embodiment of the invention when the tray 14 is open.

As shown in FIGS. 2B and 2C, the cover 11 comprises a first bent portion 11a with an upper surface 113 and a second bent portion 11b. A groove 114 is formed between the first and the second bent portions 11a and 11b.

The cover 11 corresponds to the opening 100, as shown in FIG. 2C when the tray 14 is open.

When the tray 14 is closed, that is, the tray 14 entirely in the housing 10 as shown in FIG. 2B, the cover 11 fully blocks the opening 100 such that the upper surface 113 of the cover 11 contacts the first side 12 of the housing 10. The first side 112 is disposed between the first bent portion 11a and the second bent portion 11b such that the first side 12 is partially overlaid with the first bent portion 11a. The second bent portion 11b is overlaid with the first side 12. As a result, the upper surface 113 of the cover 11 is substantially as high as the first side 12 of the housing 10.

In addition, the panel 13 of the housing 10 is disposed under the cover 11. The cover 11 and the panel 13 are aligned when the tray 14 is closed. As mentioned above, the panel 13 comprises the extending portion 131. When the tray 14 is closed, the cover 11 overlaps a portion of the extending portion 131.

When the tray 14 is closed, the cover 11 is connected to the first side 12 of the housing 10, and the front edge 121 of the first side 12 is engaged with the groove 114 of the cover 14. Thus, no gap is formed between the housing 10 and the cover 11, and structural strength is enhanced. Even if the disk D is broken at a high speed, the fragments can be completely blocked by the cover 11. As a result, the optical disk drive according to the invention minimizes risk of injury from shattered disks.

In conclusion, the invention provides a high speed optical disk drive wherein if a cracked disk is used and shatters during operation, the external structure of the optical disk drive can prevent fragments of the disk expelled therefrom, thus ensuring that the optical disk drive operates reliably and minimizes the risk of injury from shattered disks.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. An optical disk drive, comprising:
a housing, including an opening and a first side;
a tray, movably disposed in the housing, parallel to the first side and ejectable from the opening; and
a cover having an upper surface to block the opening when the tray is entirely in the housing;
wherein the upper surface of the cover is substantially as high as the first side of the housing.

2. The optical disk drive as claimed in claim 1, wherein the cover connects to the tray.

3. The optical disk drive as claimed in claim 2, wherein the upper surface contacts the first side when the tray is entirely in the housing.

4. The optical disk drive as claimed in claim 3, wherein the cover further includes a first bent portion with the upper surface to cover a part of the first side.

5. The optical disk drive as claimed in claim 3, wherein the cover further includes a second bent portion with the upper surface and the first side covers the upper surface when the tray is entirely in the housing.

6. The optical disk drive as claimed in claim 1, wherein the cover further has a groove to contain a front edge of the first side when the tray is entirely in the housing.

7. The optical disk drive as claimed in claim 1, wherein the housing further includes a panel disposed under the cover.

8. The optical disk drive as claimed in claim 7, wherein the cover and the panel are aligned when the tray is entirely in the housing.

9. The optical disk drive as claimed in claim 7, wherein the panel further includes an extending portion extending from the panel toward the tray and the cover partially overlaps the extending portion when the tray is entirely in the housing.

10. The optical disk drive as claimed in claim 9, wherein the extending portion extends a distance in the housing and turns toward the tray.

11. The optical disk drive as claimed in claim 9, wherein the extending portion has an L-shaped cross section.
